(19) United States
(12) Patent Application Publication
(10) Pub. No.: US 2019/0333413 A1
(43) Pub. Date: Oct. 31, 2019

(54) PULSATILE FLOW TASK TRAINER FOR RESUSCITATIVE ENDOVASCULAR BALLOON OCCLUSION OF THE AORTA (REBOA) DEVICE PLACEMENT

(71) Applicant: BOARD OF REGENTS, THE UNIVERSITY OF TEXAS SYSTEM, Austin, TX (US)

(72) Inventors: Frank L. Bauer, Dallas, TX (US); Matthew S. Kosemund, Grand Prairie, TX (US)

(21) Appl. No.: 16/396,232

(22) Filed: Apr. 26, 2019

Related U.S. Application Data
(60) Provisional application No. 62/663,771, filed on Apr. 27, 2018.

(51) Int. Cl. G09B 23/30; G09B 23/34

(52) U.S. Cl. CPC G09B 23/303; G09B 23/34

(57) ABSTRACT

The present invention includes a device and method for vasculature simulation device comprising: a self-contained torso model comprising an aortic conduit; a first and second femoral conduit corresponding to a human femoral artery, wherein the inner bore of the human femoral artery seamlessly transitions into the inner bore of the aortic artery; a return conduit in fluid communication with the second end of the aortic conduit; a fluid pump in fluid communication with the return conduit of the aorta and a fluid reservoir, wherein the fluid reservoir and the pump are within the torso; a return conduit connected to the fluid reservoir for returning fluid to conduits; and a replaceable penetrable material in fluid communication with the first or the second femoral conduit, wherein the replaceable penetrable material is connected to the first or the second femoral conduits seamlessly.

### CROSS-REFERENCE TO RELATED APPLICATIONS

This application claims priority to U.S. Provisional Application Ser. No. 62/663,771, filed Apr. 27, 2018, the entire contents of which are incorporated herein by reference.

### STATEMENT OF FEDERALLY FUNDED RESEARCH

Not applicable.

### TECHNICAL FIELD OF THE INVENTION

The present invention relates in general to the field of training devices for medical procedures, and more particularly, to a pulsatile flow task trainer for resuscitative endovascular balloon occlusion of the aorta (REBOA) device placement.

### BACKGROUND OF THE INVENTION

Without limiting the scope of the invention, its background is described in connection with medical training devices.

One such system is taught in Application No. PCT/US2017/013047, filed by Keller, et al., and entitled, “Systems and methods for simulating hemodynamically responsive vasculatures”. These applicants are said to teach a vasculature simulation device that includes an aortic conduit with an inner bore corresponding to a human aorta, a first femoral conduit and a second femoral conduit with an inner bore of a diameter corresponding to a human femoral artery and disposed in fluid communication with the second end of the aortic conduit, and a return conduit in fluid receiving communication with the second end of the aortic conduit. A fluid pump is connected to a return conduit that is also in fluid communication with the first end of the aortic conduit. Finally, an access site formed of a penetrable material is disposed adjacent to the first femoral conduit.

However, despite such devices, a need remains for a simulation device that more closely mimic a human torso and arteries, fluid flow, and that is cost-effective, and maximizes the simulation of a human subject.

### SUMMARY OF THE INVENTION

In one embodiment, the present invention includes a vasculature simulation device comprising: a self-contained torso model comprising: an aortic conduit having an inner bore of a diameter corresponding to an aorta from a first end to a second end; a first femoral conduit having an inner bore of a diameter corresponding to a human femoral artery and disposed in fluid communication with the second end of the aortic conduit, wherein the inner bore of the human femoral artery seamlessly transitions into the inner bore of the aortic artery; a second femoral conduit having an inner bore of a diameter corresponding to the human femoral artery contralateral to the first femoral conduit, and disposed in fluid communication with the second end of the aortic conduit, wherein the inner bore of the human femoral artery seamlessly transitions into the inner bore of the aortic artery; a return conduit in fluid communication with the second end of the aortic conduit; a fluid pump in fluid communication with the return conduit of the aorta and a fluid reservoir, wherein the fluid reservoir and the pump are within the torso; a return conduit connected to the fluid reservoir for returning fluid to the first, the second, or both the first and second femoral conduits; and a replaceable penetrable material in fluid communication with the first or the second femoral conduit, wherein the replaceable penetrable material is connected to the first or the second femoral conduits seamlessly. In one aspect, fluid pump is a gear pump that is configured to deliver a pulsatile fluid flow into the first end of the aortic conduit. In another aspect, the replaceable penetrable material is silicon, foam, gelatin, or other material that stimulates tissue surrounding a femoral artery. In another aspect, the replaceable penetrable material provides tactile detection of a pulsatile fluid flow through the replaceable penetrable material. In another aspect, the first, the second, or both femoral conduits provide tactile detection of a pulsatile fluid flow through the first or second femoral conduits. In another aspect, the device further comprises one or more sensors disposed in at least one of the aortic conduit, first femoral conduit, second femoral conduit, the reservoir, the aortic conduit, the return conduit, or the return conduit of the aorta configured to measure at least one of a simulated heart rate or a simulated blood pressure. In another aspect, the device further comprises a valve or a pump in fluid communication between the aortic return conduit and the return conduit. In another aspect, the device further comprises a power source to at least one of provide displacement for fluid in the device, to power the pump, or to power one or more controllers connected to the pump. In another aspect, the device further comprises a one-way valve configured to first flow in the device in a single direction. In another aspect, each of the first femoral conduit and the aortic conduit is formed of a visually transparent material. In another aspect, at least a portion of the torso model imitates the groins areas of a human body. In another aspect, the device further comprises a processor connected to and controlling the pump to control at least one of a flow rate, a pressure, or changes to the flow rate or pressure during a simulation of the device. In another aspect, the device is controlled by a processor connected to an application on a hand-held device, USB, computer interface, for at least one of read-out, monitoring, or control of the device. In another aspect, the device is controlled by a processor connected to an input/output device that connects via a wire, wirelessly. In another aspect, the input/output device connects to a network selected from Zigbee, Bluetooth, WiMax (WiMAX Forum Protocol), Wi-Fi (Wi-Fi Alliance Protocol), GSM (Global System for Mobile Communication), PCS (Personal Communications Services protocol), D-AMPS (Digital-Advanced Mobile Phone Service Protocol), 6LoWPAN (IPv6 Over Low Power Wireless Personal Area Networks Protocol), ANT (ANT network protocol), ANT+, Z-Wave, DASH7 (DASH7 Alliance Protocol), EnOcean, INSTEON, NeuRF ON, Senceive, WirelessHART (Wireless Highway Addressable Remote Transducer Protocol), Contiki, TinyOS (Tiny OS Alliance Protocol), GPRS (General Packet Radio Service), TCP/IP (Transmission Control Protocol and Internet Protocol), CoAP (Constrained Application Protocol), MQTT (Message Queuing Telemetry Transport), TR-50 (Engineering Committee TR-50 Protocol, OMA LW M2M (Open Mobile Alliance LightWeight machine-to-machine Protocol), and ET SIM2M (European Telecommunication Standards Institute machine-to-machine Protocol), Bluetooth Low Energy (BLE), minimal energy Bluetooth signal, Infrared Data Association (IrDA) protocols, and standards related to any of the foregoing.

In one embodiment, the present invention includes a method of a human vasculature comprising: providing a self-contained torso model comprising: an aortic conduit having an inner bore of a diameter corresponding to an aorta from a first end to a second end; a first femoral conduit having an inner bore of a diameter corresponding to a human femoral artery and disposed in fluid communication with the second end of the aortic conduit, wherein the inner bore of the human femoral artery seamlessly transitions into the inner bore of the aortic artery; a second femoral conduit having an inner bore of a diameter corresponding to the human femoral artery contralateral to the first femoral conduit, and disposed in fluid communication with the second end of the aortic conduit, wherein the inner bore of the human femoral artery seamlessly transitions into the inner bore of the aortic artery; a return conduit in fluid communication with the second end of the aortic conduit; a fluid pump in fluid communication with the return conduit of the aorta and a fluid reservoir, wherein the fluid reservoir and the pump are within the torso; a return conduit connected to the fluid reservoir for returning fluid to the first, the second, or both the first and second femoral conduits; and a replaceable penetrable material in fluid communication with the first or the second femoral conduit, wherein the replaceable penetrable material is connected to the first or the second femoral conduits seamlessly; and operating a fluid through the device that stimulates blood flow through the device to allow for the simulation of one or more stent insertions. In one aspect, fluid pump is a gear pump that is configured to deliver a pulsatile fluid flow into the first end of the aortic conduit. In another aspect, the replaceable penetrable material is silicon, foam, gelatin, or other material that stimulates tissue surrounding a femoral artery. In another aspect, the replaceable penetrable material provides tactile detection of a pulsatile fluid flow through the replaceable penetrable material. In another aspect, the first, the second, or both femoral conduits provide tactile detection of a pulsatile fluid flow through the first or second femoral conduits. In another aspect, the device further comprises one or more sensors disposed in at least one of the aortic conduit, first femoral conduit, second femoral conduit, the reservoir, the aortic conduit, the return conduit, or the return conduit of the aorta configured to measure at least one of a simulated heart rate or a simulated blood pressure. In another aspect, the device further comprises a valve or a pump in fluid communication between the aortic return conduit and the return conduit. In another aspect, the device further comprises a power source to at least one of provide displacement for fluid in the device, to power the pump, or to power one or more controllers connected to the pump. In another aspect, the device further comprises a one-way valve configured to first flow in the device in a single direction. In another aspect, each of the first femoral conduit and the aortic conduit is formed of a visually transparent material. In another aspect, at least a portion of the torso model imitates the groins areas of a human body. In another aspect, the device further comprises a processor connected to and controlling the pump to control at least one of a flow rate, a pressure, or changes to the flow rate or pressure during a simulation of the device. In another aspect, the device is controlled by a processor connected to an application on a hand-held device, USB, computer interface, for at least one of read-out, monitoring, or control of the device. In another aspect, the device is controlled by a processor connected to an input/output device that connects via a wire, wirelessly. In another aspect, the input/output device connects to a network selected from Zigbee, Bluetooth, WiMax (WiMAX Forum Protocol), Wi-Fi (Wi-Fi Alliance Protocol), GSM (Global System for Mobile Communication), PCS (Personal Communications Services protocol), D-AMPS (Digital- Advanced Mobile Phone Service Protocol), 6LoWPAN (IPv6 Over Low Power Wireless Personal Area Networks Protocol), ANT (ANT network protocol), ANT+, Z-Wave, DASH7 (DASH7 Alliance Protocol), EnOcean, INSTEON, NeuRF ON, Senceive, WirelessHART (Wireless Highway Addressable Remote Transducer Protocol), Contiki, TinyOS (Tiny OS Alliance Protocol), GPRS (General Packet Radio Service), TCP/IP (Transmission Control Protocol and Internet Protocol), CoAP (Constrained Application Protocol), MQTT (Message Queuing Telemetry Transport), TR-50 (Engineering Committee TR-50 Protocol, OMA LW M2M (Open Mobile Alliance LightWeight machine-to-machine Protocol), and ET SIM2M (European Telecommunication Standards Institute machine-to-machine Protocol), Bluetooth Low Energy (BLE), minimal energy Bluetooth signal, Infrared Data Association (IrDA) protocols, and standards related to any of the foregoing.

### BRIEF DESCRIPTION OF THE DRAWINGS

For a more complete understanding of the features and advantages of the present invention, reference is now made to the detailed description of the invention along with the accompanying figures and in which:

FIG. 1A is a flow chart of an example of an overall system block diagram of the present invention.

FIG. 1B is another flowchart with another example of an overall system block diagram of the present invention.

FIG. 2A shows one system of the present invention.

FIG. 2B shows another system of the present invention.

FIG. 3 shows a close up view of an improved bifurcated aorta for use with the TREBOA system of the present invention.

FIG. 4 shows a reservoir for use with the present invention.

FIGS. 5A and 5B show the replaceable groin of the present invention connected to tubing having quick connect attachments.

FIG. 6 shows a gear pump for use with the present invention.

FIG. 7 is a diagram that shows possible location on a torso of the various switches and the inclusion of both a vein and an artery on the contralateral sides.

FIG. 8 shows a flow chart for operation of the user interface.

FIG. 9 shows a flow chart for operation of the relief circuit.

FIG. 10 is a graph that shows the time versus voltage.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not limit the invention, except as outlined in the claims.

There is an expanding interest in the use of endovascular techniques for traumatic hemorrhages. Endovascular techniques confer several benefits, including decreased morbidity, reduced length of hospital stay, as well as quicker return to functional daily life'. In situations of aortic hemorrhage, resuscitative endovascular balloon occlusion of the aorta (REBOA) may be indicated^{2,3} and this technique is being promulgated for refractory hemorrhagic shock below the diaphragm. REBOA was first developed in the 1950s for the Korean war⁴ and is being increasingly used to quickly and effectively stop traumatic hemorrhages^{5,6}. Currently certain difficulties exist in learning this technique. Specifically, one needs to learn how to reliably gain rapid femoral artery access and then effectively manipulate a catheter device into an adequate anatomic position for deployment. Historically surgical training has consisted of progressive, graded practice on patients. In this case deployment of an endovascular device is different enough from routine general surgical and trauma practice that targeted, specific training is necessary for practitioners to gain reliable competence. Training in endovascular access and technique outside of clinical practice is necessary, especially in traumatic hemorrhage, as these situations are time sensitive and are performed in high-stress situations⁷.

The present invention is a high-fidelity simulator built for the purpose of teaching Resuscitative Endovascular Balloon Occlusion of the Aorta (REBOA). REBOA is a novel technique in trauma gaining widespread adoption for severe hemorrhagic shock. Deploying a balloon in the aorta works by increasing central blood pressure, limiting hemorrhage and bridging to definitive intervention for hemorrhage control (e.g., in an operating room). REBOA placement is a multiple step process in a high stakes scenario. Ideally practitioners would be trained via simulation prior to live placement.

The present invention includes several unique advantages over the prior art. First, the invention provides a quick connect design for replacement of an ultrasound compatible groin piece. Second, the invention includes a gear pump design to create pulsatile-flow simulating physiologic blood pressures. Additionally, the present invention can includes a battery powered with rechargeable battery, it can include 3-D printed custom aorta parts to create internal laminar flow for device deployment, which can include the actual heart in need of surgery. In addition, a unique software algorithm was developed to controlling device behavior.

Therefore, there has been increased efforts to create simulators on which medical practitioners can learn this technique⁸. Vascular surgeons are increasingly using simulation training, as they have been shown to improve proficiency in technique^{8,9}, and may be more effective for those in the early stages of their trainine¹⁰. Simulation-based training enables the trainee to learn these techniques free from the intense pressure of real-life consequences. Critically, the training can be directly mentored at varying paces with immediate feedback at the point of a procedural error and is able to provide objective feedback on performance in order to ensure a minimal level of proficiency^{9,11}. There are a few courses located in the U.S., including the Basic Endovascular Skills for Trauma (BEST)¹² course, and the Endovascular Trauma and Resuscitative Surgery (ESTARS)¹³ course. These programs provide didactic and instruction sessions coupled with a variety of endovascular training simulations. However, access to these courses is often restricted by location, time, and cost restraints.

Previous studies on simulated training have found that improved proficiency can be seen at many levels of previous experience¹⁴. Training can therefore be employed earlier in one's education, facilitating the development of basic skills such as wire and catheter handling skills, such that the more complex components of the procedure are likely to be subsequently learned more expeditiously⁹. Previous work has shown that a synthetic model can be created that is able to simulate pulsatile blood flow and physiologic responses to balloon insertion and inflation¹⁵.

There are, however, certain aspects of previous simulators that can be improved upon, namely anatomical and physiological realism, portability, reusability, learner throughput and cost. To address these limitations, the inventors developed an anatomically and physiologically realistic, highly portable, reusable, and inexpensive REBOA simulator that is able to simulate the entire REBOA procedure, from gaining access to both left and right femoral vasculature to balloon expansion and cessation of blood loss. Furthermore, the inventors demonstrate that the use of 3D printing is able to realistically create components of the training simulator. The ultimate goal of the TREBOA system is to enable the expansion of access to highly realistic REBOA training.

Current designs on the market have groin pieces that do not exchange easily and that fail after minimal use. The present invention uses a gear pump to provide a pulsatile fluid flow that more closely mimics a human blood flow through from a femoral artery to the aorta for use in guided arterial vascular access simulations, which can further recreate an ultrasound guided arterial vascular access from either femoral artery or both at the same time. Dual access allows for doubling the number of simulations, becoming comfortable with accessing either femoral artery, or for dual access necessary for certain procedures such as an endovascular aneurysm repair.

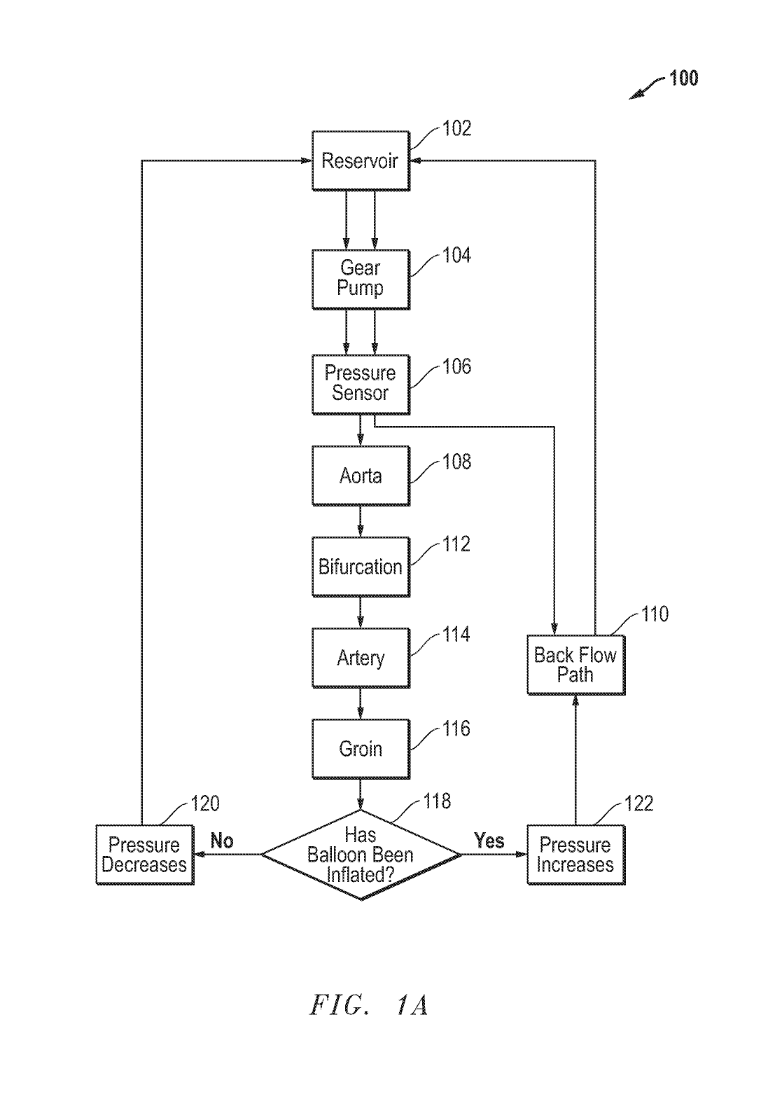

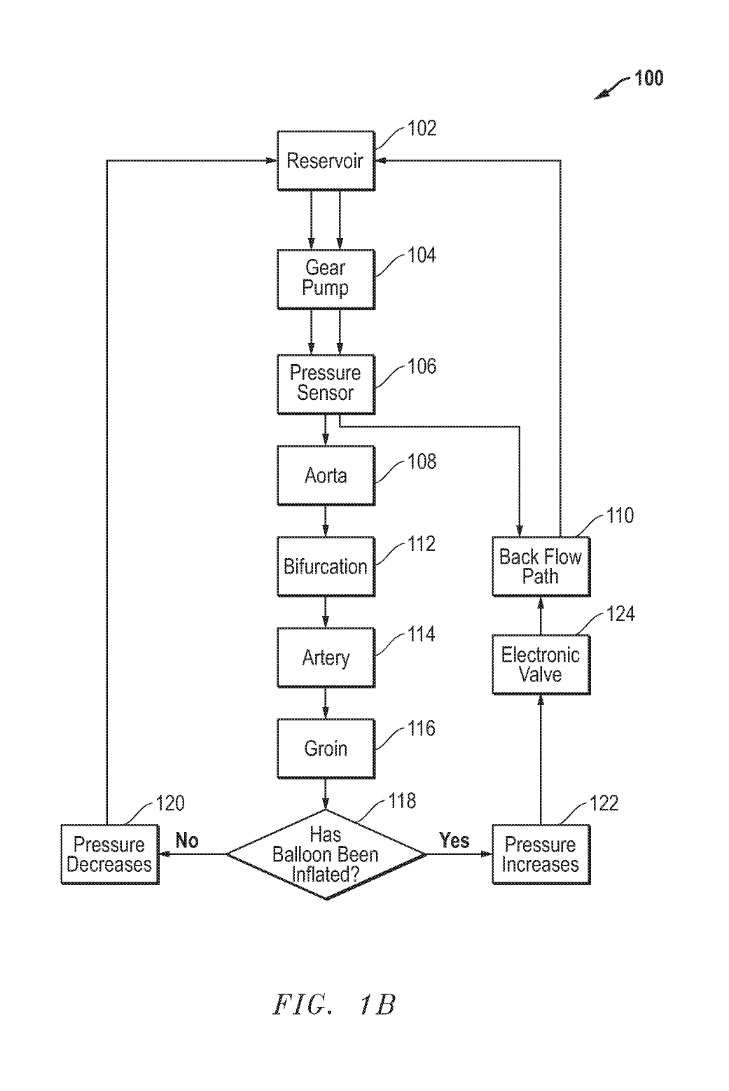

Training simulator layout. The TREBOA training simulator is designed around a mannequin modeled around a male physique in his twenties, composed of plastic to ensure a sturdy system with ease of transport (FIGS. 1A and 1B). The mannequin is stabilized via bolting to a black laminate board via holes drilled in the shoulders and buttocks. The chest can be opened in order to inspect balloon placement following insertion and inflation. The groin region is removed from the mannequin to facilitate placement of the training simulator groin. Latex-coated styrofoam and wood are used within the mannequin in order to support the tubing and internal components, as well as to create a level surface for the shoulders and buttocks. The aorta is secured to the Styrofoam via conduit clamps. The Styrofoam support is positioned in such a way as to raise the system and minimize the development of air bubbles.

A reservoir capable of holding one liter of liquid is bolted to the top of the mannequin to supply the fluid for the TREBOA training simulator. This reservoir has an inlet valve connected to the end of the closed-fluid system, an outlet valve leading to the fluid pump, and an air relief valve to prevent the development of a vacuum. A water-proof wooden box is created and placed into the mannequin in order to contain the pump, a solenoid valve, and the electrical components of the system. The box is supported in such a way as to keep the pump level within the system.

An internal, electronically-controlled positive displacement gear pump is used in order to generate a continuous fluid flow regardless of resistance, generating clinically appropriate pressure changes i.e., correct balloon placement and inflation. The fluid pulsations and pressure changes mimicking human blood flow are generated by way of a pre-scripted Pmw code fed into a microcontroller (e.g., MSP430F5529) that regulates a motor control circuit to drive the gear pump.

The progression of fluid throughout the TREBOA training simulator involves a closed-system of fluid flow including the reservoir and a series of silicone tubing and connectors, effectively simulating the vasculature system involved in traumatic hemorrhages for which REBOA is indicated. The vein system is filled with blue-colored water (therefore visibly different from the arteries), however this only consists of a short portion of vein within the ultrasound compatible groin. Once the gear pump is started, fluid begins to flow from the one-liter reservoir into silicone tubing leading to a T-connector, with one path leading to the pressure sensor and the other progressing through the system. The fluid then passes through two couplers to transition from the 3/16-inch inner diameter (ID), ⅜-inch outer diameter (OD) silicone tubing to the 1-inch ID, 1-¼ inch OD acrylic aorta; the first couple increases the tubing diameter from the 3/16-inch ID tubing to ⅜-inch ID tubing, and the second coupler is custom-made and is secured with epoxy and flew sealant that increases the ID from ⅜-inch ID to 1-inch ID to match the diameter of the aorta. Between these two couplers is attached separate silicone tubing leading to a relief valve containing a needle valve to manually tune the pressure to healthy values and then to the tubing returning from the groins; the fluid otherwise progressed through the second coupler on way to the aorta.

Following passage through the aorta, the fluid flows to a customized 3D-modeled bifurcation that reduces the 1-inch ID of the aorta back to the ⅜-inch silicone tubing leading to the groin areas. A ball valve is placed at the top of the bifurcation to allow for passage of the catheter without obstruction as well as to ensure no fluid loss occurs upon groin block removal. The fluid then flows to the groin areas leading to a T-connector to silicone tubing containing a needle valve, which serves to tune the system to the desired pressure of 70/40 mmHg at the beginning of the simulation. The progresses back to the reservoir by way of double shut-off quick connectors ensuring no fluid loss upon groin removal.

Groins. Removable, reusable groins are created to fit the groin region of the mannequin using Humimic liquid ballistic gel. This gel is highly reusable, as it is able to be melted down and recast in a matter of minutes. Critically, the gel is highly compatible with ultrasound imaging, an important component of the REBOA procedure. The process of creation of the groins is as follows: 1) a custom wooden box is created consistent with the required specifications of the groin region of the mannequin, 2) the previously removed plastic mannequin groin is placed at the bottom of the box to facilitate proper curvature, 3) the silicone tubing is then situated in the box, secured in place via zip ties and holes in the box, 4) the gel is liquefied by heat and then poured into the box and allowed to set, and 5) the set gel block is then shaved to fit the necessary specification of the mannequin groin regions. The gel block is placed on Styrofoam in order to keep the groin level with the rest of the system. Device testing demonstrated an average exchange time of 30 seconds with <1 ml system fluid loss.

Electrical components. Pressure Sensor. A pressure sensor (range 0 to 5 psi, output 0 to 5 V) is used in order to monitor the fluid pressure within the system. The pressure sensor specifications serve to detect the small pressure changes (0.77 psi to 2.12 psi) encountered during the procedure. Data from the pressure sensor is fed into the microcontroller in order to generate the appropriate pressure responses during the simulation.

Simulation buttons. A toggle switch is connected to the battery and electronic components in order to provide power to the. Upon turning the switch to on, the system enters an idle state wherein fluid from the reservoir fills the system. A second button is used to begin the simulation, starting the system pressure at 70/40 mmHg to mimic a patient experiencing severe blood loss. The pressure will then reduce to zero over the course of seven minutes without adequate REBOA intervention.

Battery. Power to the TREBOA system is supplied via a battery encased in a custom-made 3D-printed box in order to avoid damage from fluid during the procedure. A window is included in the box in order to visualize the charge indicator and the charging port.

TREBOA system testing. Several steps were taken to verify the efficacy of the system in simulating a patient experiencing hemorrhaging for which the REBOA procedure is indicated. First, the fluid flow throughout the system was tested to ensure a realistic simulation of physiological flow of blood in a human patient. Realistic flow and pressure drops were determined by calculating the Reynold's number. Flow-rate data from the pump showed that there was an exponential correspondence between flow rate and system pressure.

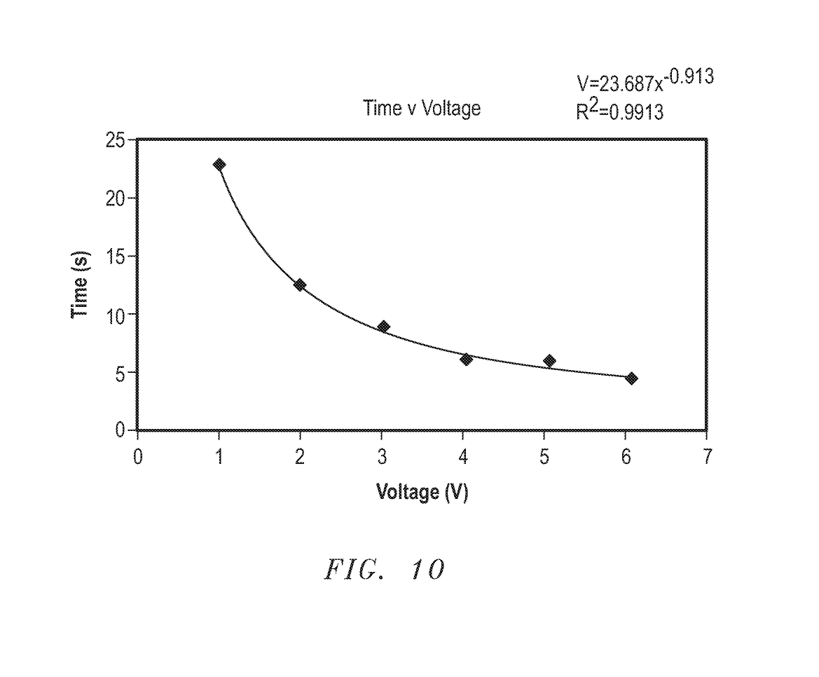

Next, the efficacy of the gear pump was tested several ways. First, in order to ensure that the rate of flow can be changed by way of varying the input voltage, a container was filled with water, into which the ends of tubing from the gear pump were placed. FIG. 10 is a graph that shows the time versus voltage. Upon providing power to the pump at various voltages, the tubing was moved to a marked empty container. The time to fill the container to the set point was then determined. This demonstrated that there was an exponential relationship between voltage and rate of fluid flow. The inventors subsequently tested the effectiveness of the microcontroller in regulating the gear pump to create realistic pulsations of the tubing with changing flow rates. The tubing was connected to the circuit powered by the DC power supply (10 V, 2A), and a current-limiting diode was connected to the microcontroller. With initiation of power to the setup, pulsations in the tubing were visualized. Critically, the coding to the microcontroller effectively decreased the pulsations over time, mimicking a patient undergoing severe blood loss. Finally, the inventors tested the ability of the pressure sensor to detect and report changes in system pressure. It was found that the pressure sensor was able to read out changes in pressure, and that pressure decreased over time without intervention.

Safety, Reliability, and Cost. The TREBOA system was determined to be very reliable for use. This was done by ranking the occurrence, severity, and control in the context of several scenarios. Three scenarios were found to be potentially troublesome for the system. First, there is the potential for the gear pump to run dry, leading to overheating. This is considered the only potential safety hazard to the user. The easily-accessible power switch enables for quick cessation of the simulation in the case of any overheating. In order to monitor for low fluid levels, a window is placed in the reservoir. Next, there is the potential for insufficient connectivity of the couplers and/or connectors, leading to the possibility of fluid leakage. Rigorous testing of the couplers and connectors over a wide range of conditions was conducted, demonstrating that these components were robust. There is also a possibility of failure of the components and valves, leading to a buildup of pressure that may cause problems such as bursting connections and rupturing of valves and/or the pump's internal seal. This concern was alleviated by successful outcomes following rigorous testing of the system across a range of possible scenarios. The total cost of the construction of the TREBOA simulator system was $1094.63, with the largest share of the cost going to the electrical transducers. Notably, the gear pump can be obtained for ˜72 dollars.

FIG. 1A is an overall system block diagram 100 of the present invention, that includes a fluid reservoir 102 connected to a gear pump 104 that is shown connected to pressure sensor 106. Fluid from the gear pump 104 enters the aorta 108, but can also be diverted to a back flow path 110. Fluid from the aorta then enters a bifurcation 112 that is connected to an artery 114 that forms a groin artery made from a penetrable material that simulates in both material and inner diameter the area surrounding and forming the artery of the groin 116. During a simulation, the system detects whether a balloon been installed at 118, wherein a pressure either decreases 120, or the pressure 122 increases, with fluid returning to the reservoir 102. In certain embodiments, a processor is connected to the pump that varies the operation of the pump 104 such that the pressure within the system is in continual decline over a predetermined period of time such that it stimulates a patient undergoing hypotension and if the procedure is not completed within the allotted time-period, the system stimulates a complete loss of pressure and death. Likewise, the processor can control the pump such that pressure is varied during the simulation. In yet another embodiment, the processor can be connected via hard-wire and/or wirelessly to the processor such that an observed and pre-program or vary in real time the pressure within the system, again more closely mimicking a real human simulation.

FIG. 1B is another example of the overall system block diagram 100 of the present invention, that also includes a fluid reservoir 102 connected to a gear pump 104 that is shown connected to pressure sensor 106. Fluid from the gear pump 104 enters the aorta 108, but can also be diverted to a back flow path 110. Fluid from the aorta then enters a bifurcation 112 that is connected to an artery 114 that forms a groin artery made from a penetrable material that simulates in both material and inner diameter the area surrounding and forming the artery of the groin 116. During a simulation, the system detects whether a balloon been installed at 118, wherein a pressure either decreases 120, or the pressure 122 increases, with fluid returning to the reservoir 102. An electronic valve 124 is positioned between the pressure sensor that measures the increase in pressure 122 and the back flow path 110. In certain embodiments, a processor is connected to the pump that varies the operation of the pump 104 such that the pressure within the system is in continual decline over a predetermined period of time such that it stimulates a patient undergoing hypotension and if the procedure is not completed within the allotted time-period, the system stimulates a complete loss of pressure and death. Likewise, the processor can control the pump such that pressure is varied during the simulation. In yet another embodiment, the processor can be connected via hard-wire and/or wirelessly to the processor such that an observed and pre-program or vary in real time the pressure within the system, again more closely mimicking a real human simulation.

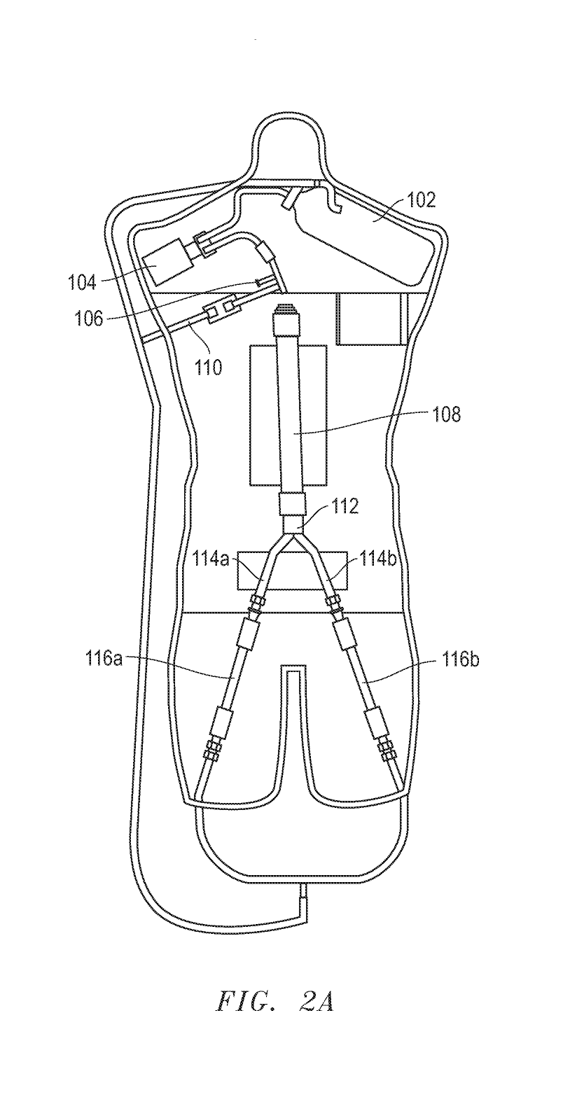

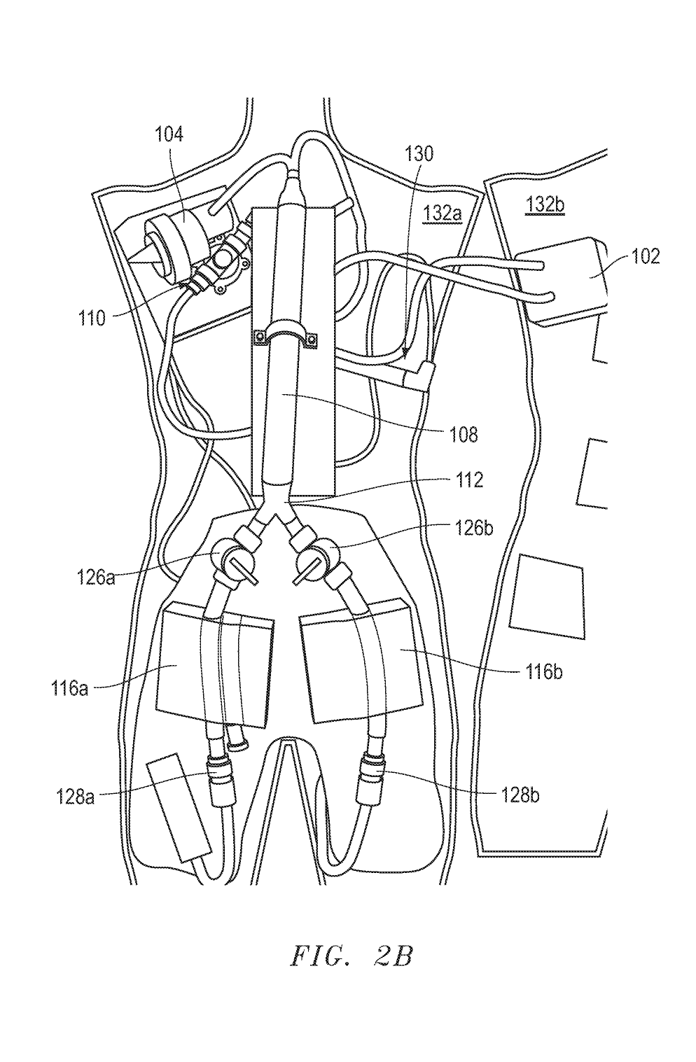

FIG. 2A shows one example of the device or system of the present invention in which a fluid reservoir 102 connected to a gear pump 104 that is shown connected to pressure sensor 106. Fluid from the gear pump 104 enters the aorta 108, but can also be diverted to a back flow path 110. Fluid from the aorta then enters a bifurcation 112 that is connected to an artery 114a, 114b that forms a groin artery made from a penetrable material that simulates in both material and inner diameter the area surrounding and forming the artery of the groin 116a, 116b, with fluid returning to the reservoir 102.

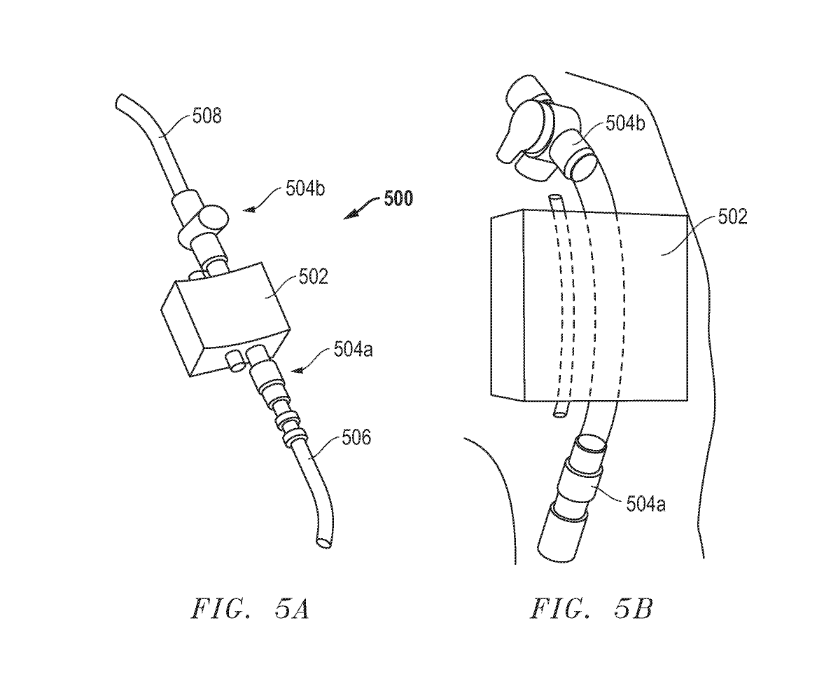

FIG. 2B shows another system of the present invention in which the fluid reservoir 102 connected to a gear pump 104 that is shown connected to pressure sensor 130. Fluid from the gear pump 104 enters the aorta 108, but can also be diverted to a back flow path 110. Fluid from the aorta then enters a bifurcation 112 that is connected to an artery 114a, 114b that forms a groin artery made from a penetrable material that simulates in both material and inner diameter the area surrounding and forming the artery of the groin 116a, 116b (See FIGS. 5A and 5B for details of groin gel packs), in this version shown with ball valves 126a, 126b, with fluid returning to the reservoir 102 with double shut-offs 128a, 128b. During operation the entire system is encased in a torso 132a, 132b.

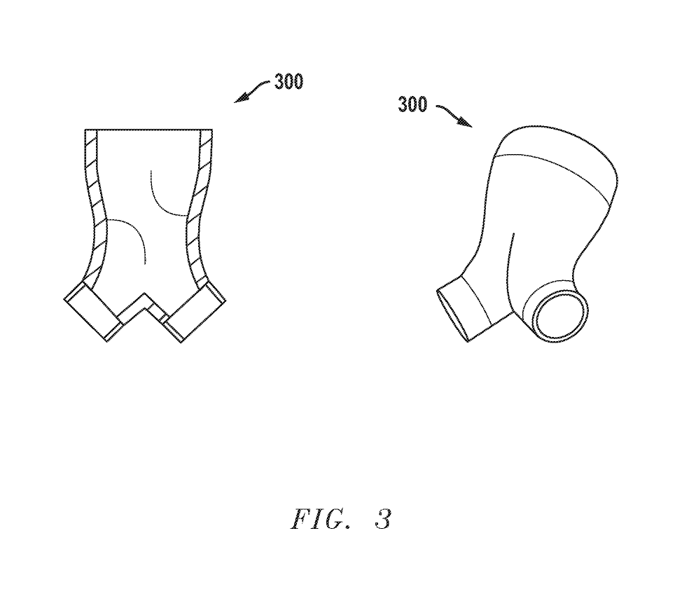

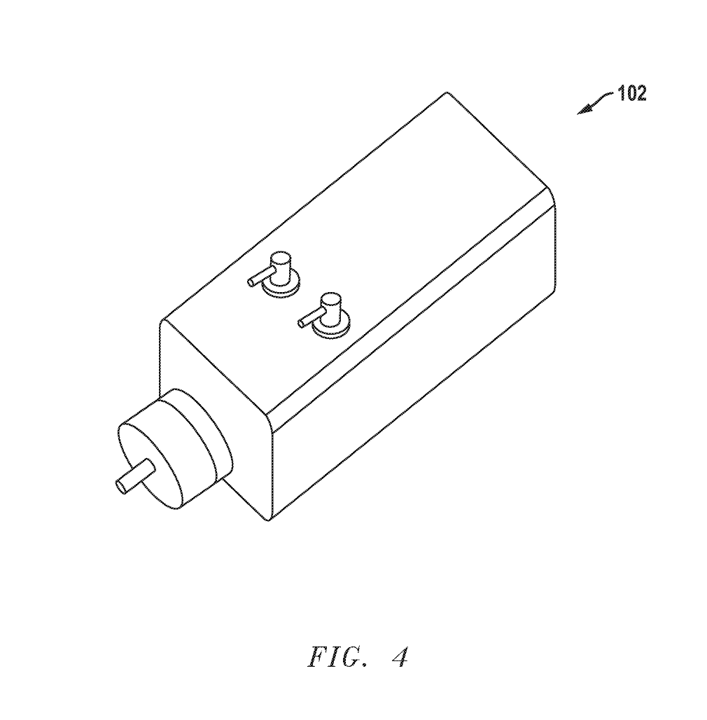

FIG. 3 shows a close up view of an improved bifurcated aorta 300 for use with the TREBOA system of the present invention showing both a cross-sectional and three-dimensional view. FIG. 4 shows a reservoir for use with the present invention.

FIG. 5A and 5B show the replaceable penetrable material 500 that includes a portion or simulation of a groin 502 for use with the present invention. The groin 502 connects seamlessly via quick connect attachments 504a, 504b and also seamlessly to conduits 506 and 508 that provide fluid from the aorta and to the fluid reservoir. The groin 502 can be varied in material, thickness and total area to mimic as closely as possible different possible groin scenarios, such as a pediatric versus an adult, or a male versus female anatomy. Further, the artery within the groin 502 can be located in a deep location versus closer to the surface of the skin, and the size of the artery can also be varied in one or both sides. In certain examples, the groin 502 can be custom made to have the exact dimensions of an actual patient prior to the procedure, which dimensions can be obtained from a wide variety of soft tissue images, such as PET or CAT scans, ultrasound, and the like. The material for the groin 502 can be selected to be radiolucent such that it can be imaged in certain uses. Examples of polymers for use with the present invention include both natural and synthetic polymers. Examples of polymers include hydrogel-forming polymers such as collagens, gelatins, fibrins, alginates, chitosans, polylactic acid, poly(propylene fumarate) copolymers, polyethylene glycols, and polyvinyl acetates.

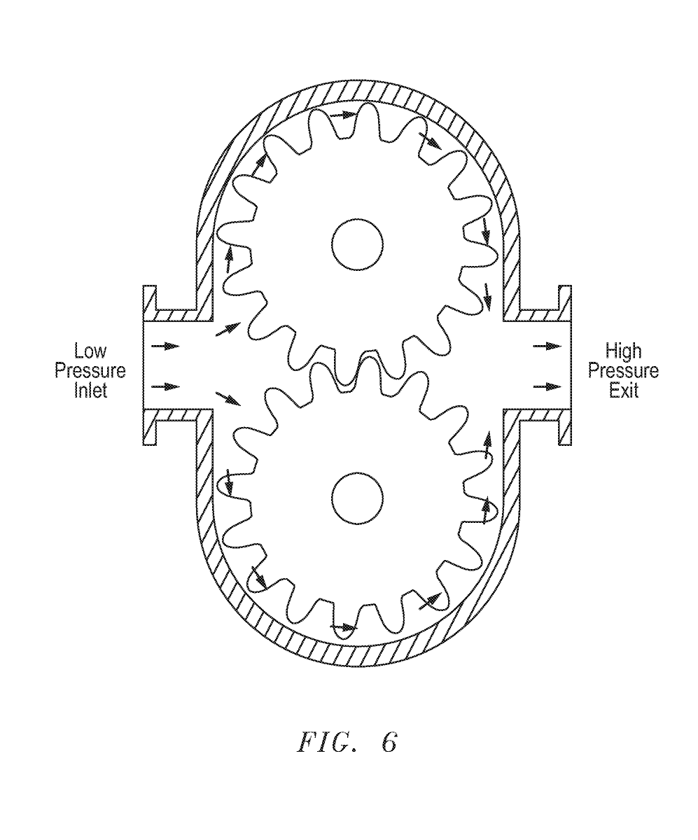

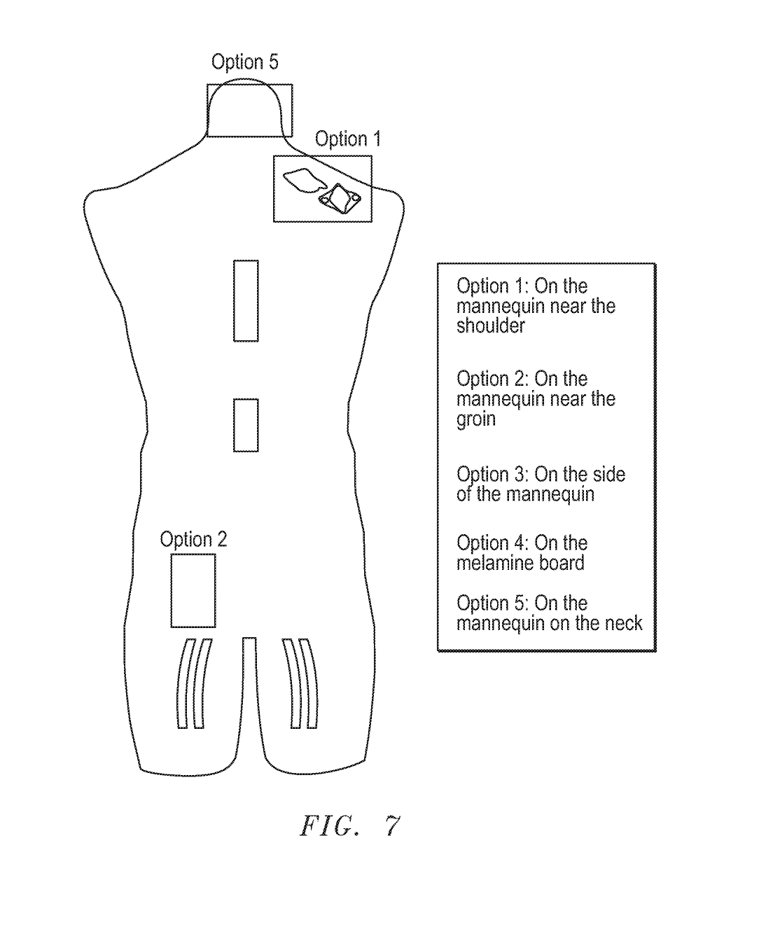

FIG. 6 shows a cross-sectional view of a gear pump for use with the present invention. FIG. 7 is a diagram that shows possible location on a torso of the various switches and the inclusion of both a vein and an artery on the contralateral sides.

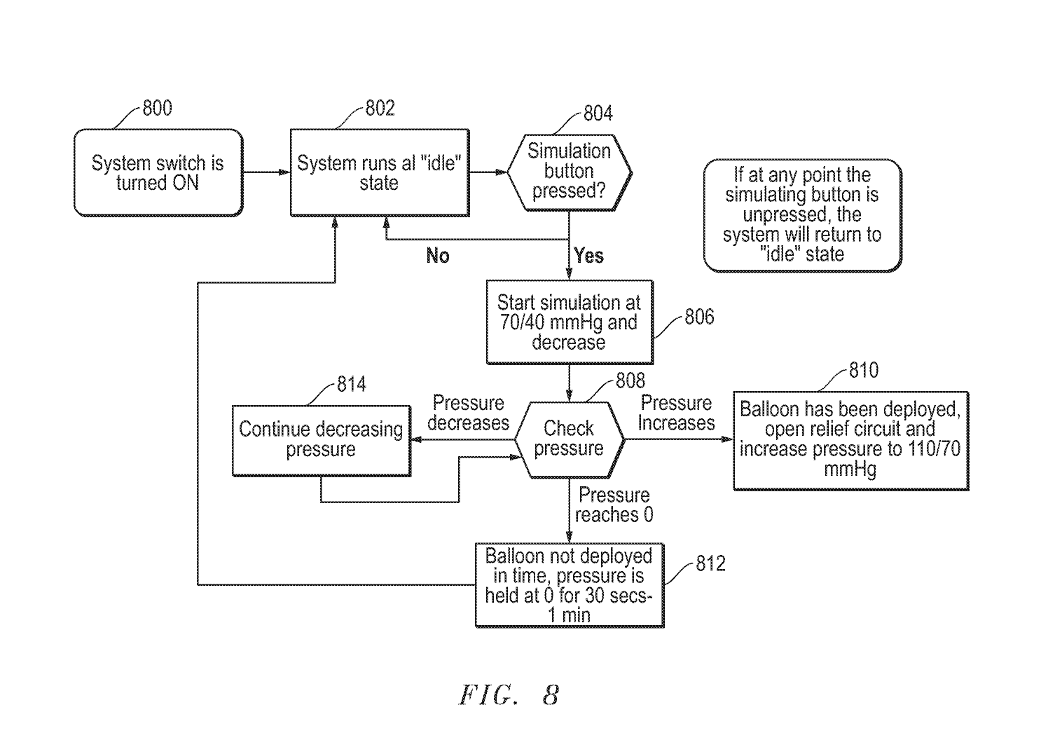

FIG. 8 shows a flow chart for operation of the user interface. In block 800, the system switch is turned on. After the system switch is turned on, the system runs in an idle state at block 802. In block 804, the status of the simulation button is checked. If it has been pressed, the simulation is started at 70/40 mmHg and that value is then decreased in block 806. If the simulation button has not been pressed, the system continues in an idle state, according to block 802. After the simulation has begun in block 806, pressure is checked.

If the pressure increases, the balloon has been deployed, and according to block 810, the relief circuit is opened and the pressure is increased to 110/70 mmHg. If the pressure reaches zero, the balloon has not been deployed, and block 812 requires the pressure to be held at zero for 30 seconds to 1 minute and the system returns to the idle state of block 802. If the pressure decreases, it continues to decrease according to block 814. If at any point the simulation button is unpressed, the system returns to the idle state of block 802.

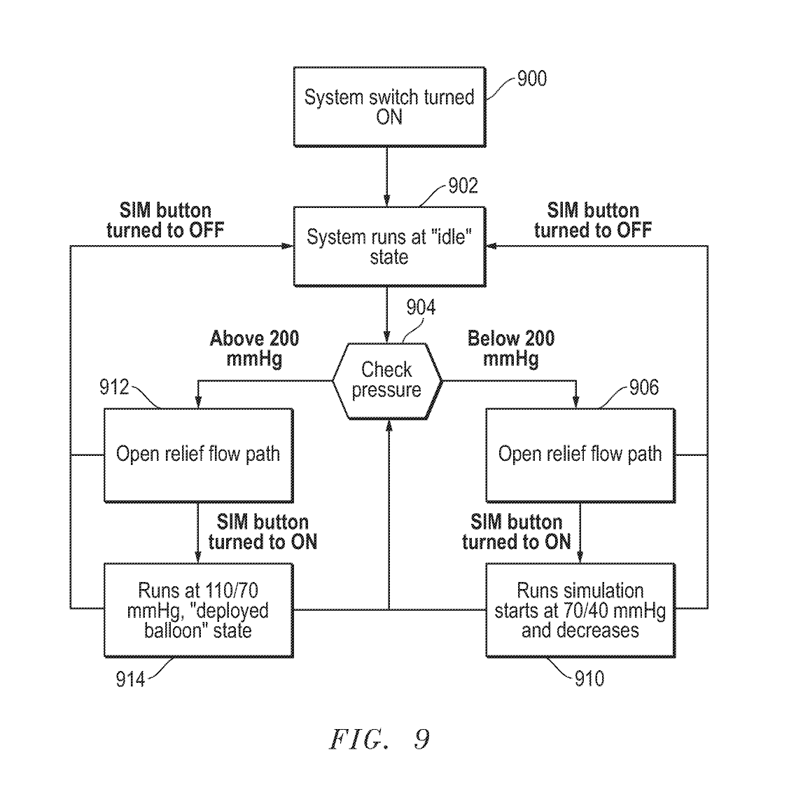

FIG. 9 shows a flow chart for operation of the relief circuit. Operation begins at block 900 with turning the system switch on. After the system switch is turned on, the system runs in an idle state at block 902. According to block 904, the pressure is checked. If the pressure is below 200 mmHg, the relief flow path is closed in block 906. If the simulation button is turned to on, the simulation is run in block 910, starting at 70/40 mmHg and decreasing. The pressure is checked again according to block 904. If the simulation button is turned off, the system returns to the idle state of block 902. If the pressure is above 200 mmHg, the relief flow path is opened in block 912. If the simulation button is turned on, the simulation runs at 110/70 mmHg in the “deployed balloon” state in block 914. If the simulation button is turned off, the system returns to the idle state of block 902.

Endovascular interventions are increasingly deployed to stabilize individuals that are experiencing severe hemorrhage¹⁶. Traditionally, REBOA training has been conducted via progressive exposure and practice in real-life situations. This complicates the learning process, as the situations in which REBOA are used are generally high-stress and highly time sensitive. Various training methods have been developed to help address these concerns by way of simulation of the procedure.

There are a few courses located in the U.S., including Basic Endovascular Skills for Trauma (BEST)¹² and Endovascular Trauma and Resuscitative Surgery (ESTARS)¹³. These courses provide didactic and instruction sessions coupled with a variety of endovascular training simulations, predominantly via the use of perfused cadavers, virtual reality (VR) devices, and animal models^{12,13}. However, each of these have their particular weaknesses⁷. The cadaver model is a single-use procedure, is not portable, and requires a high cost to conduct. VR models, while re-usable and portable, involve very high costs and are less similar to real life situations. Finally, animal models are single-use procedures, involve differences from human anatomy, specific facilities, and are also high in cost.

Synthetic biomechanical simulators are gaining interest as a way to address these short-comings. A previous synthetic model was developed by Keller and colleagues¹⁵. This system consists of a vascular circuit simulating the abdominal aorta, iliac bifurcation, common iliac arteries, and common femoral arteries supplied by an external pulsatile perfusion pump. In certain embodiment, the pump can be located internally and a contralateral femoral artery can be added and used for, e.g., pressure monitoring.

The simulation device of the present invention simulates the entire procedure from access to placement to withdrawal of the device. The device is extremely functional with ultrasound and is tailored for high throughput of learners. The self-contained device includes the physiologic pump and power source, which was accomplished at a fraction of the cost of previous devices. The device can be customized with additional simulations and functionality, e.g., coiling simulation or EVAR).

The TREBOA training simulator of the present invention has several benefits over previous simulator models. Key innovations include a gear pump to drive physiologic pressure, truly exchangeable groins and the use of custom 3D printed parts. The construction and layout of the system is a more realistic representation of human anatomy and physiology, including both left and right groin access that can be used simultaneously. The TREBOA simulator is therefore able to simulate clinical scenarios where bilateral groin access is required. Whereas other synthetic simulators have vascular access already in place the training model begins with the need to access the femoral arteries, as one would need to do in real-life situations. The gel is also highly compatible with ultrasound, a critical component of the REBOA procedure. Fluid flow throughout the system is electronically controllable by way of custom coding fed into a microcontroller and is thus able to simulate pulsatile flow over a range of rates and pressures. Upon initiation of the simulation, the fluid pressure begins are pressure levels consistent with a patient experiencing hemorrhagic shock, dropping to zero over the course of seven minutes without intervention. Upon deployment of the balloon, fluid pressure returns to a healthy stable range, consistent with successful performance of the procedure. All together, these advancements enable the TREBOA system to provide the trainee a highly-realistic simulation of a human experiencing traumatic hemorrhagic shock and the successful deployment of the REBOA procedure.

In addition to this highly realistic simulation, TREBOA has several other advantages over other simulators, including reusability, portability, and cost. TREBOA is high reusable, as the groins can be reused up to 15 times before being replaced, and the Humimic ballistic gel is able to be melted and recast in a matter of minutes. The groin system therefore enables the training of multiple individuals in a single session. TREBOA is also very portable, as all components are placed internal to the mannequin and can be transported in a single container. This also means that, as the gear pump and fluid reservoir are internally-placed, there is no need for external fluid containment and flow. Another significant advantage of TREBOA is the cost of construction, as the entire system can be built for approximately $1000. Another unique aspect of the TREBOA system is the use of 3D printing for several of its components. The developmental process showed that 3D printing can be effectively used to recreate human anatomical structures. The use of 3D printing is expanding greatly over recent years due to its increasing availability and decreasing costs. This means that the TREBOA system can be recreated relatively easily at a rather low cost. Finally, TREBOA does not require specialized facilities and is free of ethical concerns. Taken together, this simulator provides the capability to greatly expand access to realistic training on the REBOA procedure.

In summary, TREBOA is a realistic simulation of a patient dying from hemorrhagic shock. Critically, the TREBOA trainer system is self-contained, portable, multiply reusable and customizable while maintaining anatomic and procedural fidelity. Future directions could include customizing the simulator to simulate more advanced scenarios such as EVAR or coiling.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), property(ies), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

### REFERENCES

1. Drury D, Michaels J A, Jones L, Ayiku L. Systematic review of recent evidence for the safety and efficacy of elective endovascular repair in the management of infrarenal abdominal aortic aneurysm. Br J Surg. 2005;92(8):937-946. doi:10.1002/bjs.5123.

2. Gupta B K, Khaneja S C, Flores L, Eastlick L, Longmore W, Shaftan G W. The role of intra-aortic balloon occlusion in penetrating abdominal trauma. J Trauma. 1989;29(6):861-865. http://www.ncbi.nlm.nih.gov/pubmed/2661845. Accessed Mar. 11, 2019.

3. Martinelli T, Thony F, Decléty P, et al. Intra-Aortic Balloon Occlusion to Salvage Patients With Life-Threatening Hemorrhagic Shocks From Pelvic Fractures. J Trauma Inj Infect Crit Care. 2010;68(4):1. doi:10.1097/TA.0b013e3181c40579.

4. HUGHES C W. Use of an intra-aortic balloon catheter tamponade for controlling intra-abdominal hemorrhage in man. Surgery. 1954;36(1):65-68. http://www.ncbi.nlm.nih.gov/pubmed/13178946. Accessed Mar. 11, 2019.

5. Moore L J, Martin C D, Harvin J A, Wade C E, Holcomb J B. Resuscitative endovascular balloon occlusion of the aorta for control of noncompressible truncal hemorrhage in the abdomen and pelvis. Am J Surg. 2016;212(6):1222-1230. doi :10.1016/j .amj surg.2016.09.027.

6. Osborn L A, Brenner M L, Prater S J, Moore L J. Resuscitative endovascular balloon occlusion of the aorta: current evidence. Open Access Emerg Med. 2019;Volume 11:29-38. doi: 10.2147/0AEM. S166087.

7. Neequaye S K, Aggarwal R, Van Herzeele I, Darzi A, Cheshire N J. Endovascular skills training and assessment. J Vasc Surg. 2007;46(5):1055-1064. doi:10.1016/j .jvs.2007.05.041.

8. Tedesco M M, Pak J J, Harris E J, Krummel T M, Dalman R L, Lee J T.

Simulation-based endovascular skills assessment: The future of credentialing? J Vasc Surg. 2008;47(5):1008-1014. doi:10.1016/j.jvs.2008.01.007.

9. Aggarwal R, Black S A, Hance J R, Darzi A, Cheshire N J W. Virtual Reality Simulation Training can Improve Inexperienced Surgeons' Endovascular Skills. Eur J Vasc Endovasc Surg. 2006;31(6):588-593. doi:10.1016/j.ejvs.2005.11.009.

10. Dayal R, Faries P L, Lin S C, et al. Computer simulation as a component of catheter-based training. J Vasc Surg. 2004;40(6):1112-1117. doi:10.1016/j .jvs.2004.09.028.

11. Moorthy K, Vincent C, Darzi A. Simulation based training. BMJ. 2005;330(7490):493-494. doi:10.1136/bmj.330.7490.493.

12. Brenner M, Hoehn M, Pasley J, Dubose J, Stein D, Scalea T. Basic endovascular skills for trauma course. J Trauma Acute Care Surg. 2014;77(2):286-291. doi:10.1097/TA.0000000000000310.

13. Villamaria C Y, Eliason J L, Napolitano L M, Stansfield R B, Spencer J R, Rasmussen T E. Endovascular Skills for Trauma and Resuscitative Surgery (ESTARS) course: curriculum development, content validation, and program assessment. J Trauma Acute Care Surg. 2014;76(4):929-35; discussion 935-6. doi:10.1097/TA.0000000000000164.

14. See KWM, Chui K H, Chan W H, Wong K C, Chan Y C. Evidence for Endovascular Simulation Training: A Systematic Review. Eur J Vasc Endovasc Surg. 2016;51(3):441-451. doi:10.1016/j.ejvs.2015.10.011.

15. Keller B A, Salcedo E S, Williams T K, et al. Design of a cost-effective, hemodynamically adjustable model for resuscitative endovascular balloon occlusion of the aorta (REBOA) simulation. J Trauma Acute Care Surg. 2016;81(3):606-611. doi:10.1097/TA.0000000000001153.

16. Pedersen R C, Li Y, Chang J S, Lew W K, Patel K (Kevin). Effect of Endovascular Interventions on General Surgery Trainee Operative Experience; a Comparison of Case Log Reports. Ann Vasc Surg. 2016;33:98-102. doi:10.1016/j.aysg.2016.02.008.

What is claimed is:

1. A vasculature simulation device comprising:
a self-contained torso model comprising:
an aortic conduit having an inner bore with a diameter corresponding to an aorta from a first end to a second end;
a first femoral conduit having an inner bore of a diameter corresponding to a human femoral artery and disposed in fluid communication with the second end of the aortic conduit, wherein the inner bore of the human femoral artery seamlessly transitions into an inner bore of an aortic artery;
a second femoral conduit having an inner bore of a diameter corresponding to the human femoral artery contralateral to the first femoral conduit, and disposed in fluid communication with the second end of the aortic conduit, wherein the inner bore of the human femoral artery seamlessly transitions into the inner bore of the aortic artery;
a first return conduit in fluid communication with the second end of the aortic conduit;
a fluid pump in fluid communication with the return conduit of the aorta and a fluid reservoir, wherein the fluid reservoir and the fluid pump are within a torso;
a second return conduit connected to the fluid reservoir to return fluid to the first, the second, or both the first and second femoral conduits; and
a replaceable penetrable material in fluid communication with the first or the second femoral conduit, wherein the replaceable penetrable material is connected to the first or the second femoral conduits seamlessly.

2. The device of claim 1, wherein the fluid pump is a gear pump delivers a pulsatile fluid flow into at least one of: (1) the first end of the aortic conduit, (2) the first femoral conduit; or (3) the second femoral conduit.

3. The device of claim 1, wherein the replaceable penetrable material is at least one of:
(1) silicon, foam, gelatin, or other material that stimulates tissue surrounding a femoral artery; or (2) provides tactile detection of a pulsatile fluid flow through the replaceable penetrable material.

4. The device of claim 1, further comprising at least one of:
(1) one or more sensors disposed in at least one of the aortic conduit, first femoral conduit, second femoral conduit, the reservoir, the aortic conduit, the return conduit, or the return conduit of the aorta to measure at least one of a simulated heart rate or a simulated blood pressure;
(2) a valve or a fluid pump in fluid communication between the first return conduit and the second return conduit;
(3) a power source to at least one of provide displacement for fluid in the device, to power the fluid pump, or to power one or more controllers connected to the fluid pump; or
(4) a one-way valve to provide the first flow in the device in a single direction.

5. The device of claim 1, wherein each of the first femoral conduit and the aortic conduit is formed of a visually transparent material.

6. The device of claim 1, wherein at least a portion of the torso model imitates groins areas of a human body.

7. The device of claim 1, wherein the torso comprises one or more landmarks that include a neck and a groin, and wherein an access site is disposed at the groin.

8. The device of claim 1, further comprising a processor connected to and controlling the gear pump to control at least one of a flow rate, a pressure, or changes to the flow rate or pressure during a simulation of the device.

9. The device of claim 8, wherein the device is controlled by a processor connected to an application on a hand-held device, USB, computer interface, for at least one of read-out, monitoring, control of the device or an input/output device that connects via a wire, wirelessly.

10. The device of claim 9, wherein the input/output device connects to a network selected from Zigbee, Bluetooth, WiMax (WiMAX Forum Protocol), Wi-Fi (Wi-Fi Alliance Protocol), GSM (Global System for Mobile Communication), PCS (Personal Communications Services protocol), D-AMPS (Digital-Advanced Mobile Phone Service Protocol), 6LoWPAN (IPv6 Over Low Power Wireless Personal Area Networks Protocol), ANT (ANT network protocol), ANT+, Z-Wave, DASH7 (DASH7 Alliance Protocol), EnOcean, INSTEON, NeuRF ON, Senceive, WirelessHART (Wireless Highway Addressable Remote Transducer Protocol), Contiki, TinyOS (Tiny OS Alliance Protocol), GPRS (General Packet Radio Service), TCP/IP (Transmission Control Protocol and Internet Protocol), CoAP (Constrained Application Protocol), MQTT (Message Queuing Telemetry Transport), TR-50 (Engineering Committee TR-50 Protocol, OMA LW M2M (Open Mobile Alliance LightWeight machine-to-machine Protocol), and ETSIM2M (European Telecommunication Standards Institute machine-to-machine Protocol), Bluetooth Low Energy (BLE), minimal energy Bluetooth signal, Infrared Data Association (IrDA) protocols, and standards related to any of the foregoing.

11. A method of a human vasculature training using a device comprising:
providing a self-contained torso model for human vasculature training comprising:
an aortic conduit having an inner bore of a diameter corresponding to an aorta from a first end to a second end;
a first femoral conduit having an inner bore of a diameter corresponding to a human femoral artery and disposed in fluid communication with the second end of the aortic conduit, wherein the inner bore of a human femoral artery seamlessly transitions into the inner bore of an aortic artery;
a second femoral conduit having an inner bore of a diameter corresponding to the human femoral artery contralateral to the first femoral conduit, and disposed in fluid communication with the second end of the aortic conduit, wherein the inner bore of the human femoral artery seamlessly transitions into the inner bore of the aortic artery;
a return conduit in fluid communication with the second end of the aortic conduit;
a fluid pump in fluid communication with the return conduit of the aorta and a fluid reservoir, wherein the fluid reservoir and the fluid pump are within the torso;
a return conduit connected to the fluid reservoir for returning fluid to the first, the second, or both the first and second femoral conduits; and
a replaceable penetrable material in fluid communication with the first or the second femoral conduit, wherein the replaceable penetrable material is connected to the first or the second femoral conduits seamlessly; and
operating a fluid through the device that stimulates blood flow through the device to allow for the simulation of one or more stent insertions to provide human vasculature training.

12. The method of claim 11, wherein the fluid pump is a gear pump that is configured to deliver a pulsatile fluid flow into at least one of: (1) the first end of the aortic conduit, (2) the first femoral conduit; or (3) the second femoral conduit.

13. The method of claim 11, wherein the replaceable penetrable material is at least one of: (1) silicon, foam, gelatin, or other material that stimulates tissue surrounding a femoral artery; or (2) the replaceable penetrable material provides tactile detection of a pulsatile fluid flow through the replaceable penetrable material.

14. The method of claim 11, further comprising at least one of:
(1) one or more sensors disposed in at least one of the aortic conduit, first femoral conduit, second femoral conduit, the reservoir, the aortic conduit, the return conduit, or the return conduit of the aorta configured to measure at least one of a simulated heart rate or a simulated blood pressure;
(2) a valve or a pump in fluid communication between the first return conduit and the second return conduit;
(3) a power source to at least one of provide displacement for fluid in the device, to power the fluid pump, or to power one or more controllers connected to the fluid pump; or
(4) a one-way valve configured to first flow in the device in a single direction.

15. The method of claim 11, wherein each of the first femoral conduit and the aortic conduit is formed of a visually transparent material.

16. The method of claim 11, wherein at least a portion of the torso model imitates the groins areas of a human body.

17. The method of claim 11, wherein the landmarks include a neck and a groin, and wherein the access site is disposed at the groin.

18. The method of claim 11, further comprising a processor connected to and controlling the pump to control at least one of a flow rate, a pressure, or changes to the flow rate or pressure during a simulation of the device.

19. The method of claim 11, wherein the device is controlled by a processor connected to an application on a hand-held device, USB, computer interface, for at least one of read-out, monitoring, control of the device, or is connected to an input/output device that connects via a wire, wirelessly.

20. The method of claim 19, wherein the input/output device connects to a network selected from Zigbee, Bluetooth, WiMax (WiMAX Forum Protocol), Wi-Fi (Wi-Fi Alliance Protocol), GSM (Global System for Mobile Communication), PCS (Personal Communications Services protocol), D-AMPS (Digital-Advanced Mobile Phone Service Protocol), 6LoWPAN (IPv6 Over Low Power Wireless Personal Area Networks Protocol), ANT (ANT network protocol), ANT+, Z-Wave, DASH7 (DASH7 Alliance Protocol), EnOcean, INSTEON, NeuRF ON, Senceive, WirelessHART (Wireless Highway Addressable Remote Transducer Protocol), Contiki, TinyOS (Tiny OS Alliance Protocol), GPRS (General Packet Radio Service), TCP/IP (Transmission Control Protocol and Internet Protocol), CoAP (Constrained Application Protocol), MQTT (Message Queuing Telemetry Transport), TR-50 (Engineering Committee TR-50 Protocol, OMA LW M2M (Open Mobile Alliance LightWeight machine-to-machine Protocol), and ETSIM2M (European Telecommunication Standards Institute machine-to-machine Protocol), Bluetooth Low Energy (BLE), minimal energy Bluetooth signal, Infrared Data Association (IrDA) protocols, and standards related to any of the foregoing.
